(19) United States
(12) Patent Application Publication
(10) Pub. No.: US 2006/0181200 A1
(43) Pub. Date: Aug. 17, 2006

(54) Silane compound, organic electroluminescent device and display panel using the same

(76) Inventor: Min-Ling Hung, Kanding Township (TW)

Correspondence Address: RABIN & Berdo, PC, 1101 14TH STREET, NW, SUITE 500, WASHINGTON, DC, 20005, US

(21) Appl. No.: 11/199,144

(22) Filed: Aug. 9, 2005

(30) Foreign Application Priority Data
Feb. 16, 2005 (TW) 94104552

(51) Int. Cl. C07F 7/02; H01J 1/62

(52) U.S. Cl. 313/504; 548/406

(57) ABSTRACT

An organic electroluminescent device (OELD) using at least one silane compound is applied to a display panel. The OELD at least comprises an anode; a hole transport layer formed on the anode; a light emitting layer formed on the hole transport layer; an electron transport layer formed on the light emitting layer, and a cathode formed on the electron transport layer. The electron transport layer substantially includes a silane compound represented by a general formula: 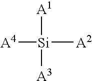
wherein A¹.A².A³ and A⁴, which may be the same or different, each represents an alkyl group, an aryl group, a heteroaryl group or an alkynyl group.

This application claims the benefit of Taiwan application Serial No. 094104552, filed Feb. 16, 2005, the subject matter of which is incorporated herein by reference.

### BACKGROUND OF THE INVENTION

1. Field of the Invention

The invention relates in general to an organic electroluminescent device and a display panel using the same, and more particularly to the organic electroluminescent device with an electron transport layer including a silane compound.

2. Description of the Related Art

Use of an organic electroluminescence device (OELD) in the flat panel displays possesses several competitive advantages, such as self illumination, high brightness, wide viewing angle, vivid contrast, quick response, broad range of operating temperature, high luminous efficiency and uncomplicated process of fabrication. Thus, the OELD represents a promising technology for display applications and receives the worldwide attention in recent years.

The typical structure of OELD is mainly constructed by interposing an organic light emitting layer between an anode and a cathode. A hole injection layer (HIL) and a hole transport layer (HTL) are interposed between the anode and the organic light emitting layer. An electron transport layer (ETL) is interposed between the cathode and the organic light emitting layer. Also, an electron injection layer (EIL) can be disposed between the electron transport layer and the cathode, for improving the performance of OELD. The OELD has an organic dye, which consists of exciton states. These consist of an excited electron and a hole or empty state. When the hole and electron combine, a photon is emitted and light is produced. Additionally, the organic light emitting layer can be divided into tow groups according to the materials in use. One group is a small molecule-based light emitting diode, substantially comprising the dyestuffs or pigments, and so called as “OLED” (i.e. organic light emitting diode) or “OEL” (i.e. organic electroluminescence). The other group is a polymer-based light emitting diode, so called as “PLED” (i.e. polymer light emitting diode) or “LEP” (i.e. light emitting polymer).

The conventional electron transporting material is aluminum tris(8-hydroxyquinolate) (also known as Alq₃), which is an organic metal complex having good light and thermal stabilities. However, the recent researches have reported that Alq₃ turns to Alq₃⁺ easily if too many holes presented, and unstable Alq₃⁺ is a one of the key factors for decreasing the operation efficiency and useful life of the organic electroluminescence device. Thus, it is desirable to find the suitable material of the electron transport layer, for replacing Alq₃ and increasing the operation efficiency and extending the useful life of the OELD.

### SUMMARY OF THE INVENTION

It is therefore an object of the invention to provide an organic electroluminescence device (OELD) with long useful life and good operation efficiency.

The invention achieves the objects by providing an organic electroluminescence device (OELD), at least comprising an anode, a hole transport layer formed above the anode, an organic light emitting layer formed above the hole transport layer, an electron transport layer formed above the organic light emitting layer, and a cathode formed above the electron transport layer. The electron transport layer includes a silane compound represented by a general formula:

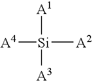

wherein A¹, A², A³ and A, may be the same or different, each of which represents an alkyl group, an aryl group, a heteroaryl group or an alkynyl group.

The invention achieves the objects by providing an electroluminescent display panel at least comprising the organic electroluminescent device described above.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 schematically illustrates an organic electroluminescence device (OELD) according to the embodiment of the present invention.

FIG. 2 shows the results of the light-emitting efficiency of the OELD structures of comparative example and inventive example according to the embodiment of the present invention.

FIG. 3A and FIG. 3B show the results of CIE colors of the light emitted from the OELD structures of comparative example and inventive example according to the embodiment of the present invention.

### DETAILED DESCRIPTION OF THE INVENTION

In the present invention, an organic electroluminescent device (OELD) with an electron transport layer including a silane compound is provided. The conventional material Alq₃ used for the electron transport layer is replaced by a silane compound for increasing the operation efficiency and extending the useful life of the OELD. Accordingly, the display panel using the organic electroluminescent device of the invention presents a good image quality. A preferred embodiment disclosed herein is used for illustrating the invention, but not for limiting the scope of the invention. Additionally, the drawings used for illustrating the embodiments of the invention only show the major characteristic parts in order to avoid obscuring the invention. Accordingly, the specification and the drawings are to be regarded as an illustrative sense rather than a restrictive sense.

Moreover, the organic light emitting layer of the organic electroluminescence device can be divided into two groups according to the materials in use. One group is a molecule-based light emitting diode, substantially comprising the dyestuffs or pigments, and so called as “OLED” (i.e. organic light emitting diode) or “OEL” (i.e. organic electroluminescence). The other group is a polymer-based light emitting diode, so called as “PLED” (i.e. polymer light emitting diode) or “LEP” (i.e. light emitting polymer). The encapsulation structure of the embodiment could be applicable, and not limited, to encapsulate the “OLED” or “PLED”.

FIG. 1 schematically illustrates an organic electroluminescence device (OELD) according to the embodiment of the invention. The OELD 1 comprises an anode 10, a hole injection layer (HIL) 12 formed on the anode 10, a hole transport layer (HTL) 14 formed on the HIL 12, an organic light emitting layer 16 formed on the HTL 14, an electron transport layer (ETL) 18 formed on the organic light emitting layer 16, an electron injection layer (EIL) 20 formed on the ETL 18, and a cathode 22 formed on the EIL 20.

It is, of course, understood that the hole injection layer (HIL) 12 and the electron injection layer (EIL) 20 are not necessary to the OELD, but are existed for increasing injection ability of the electrons and holes.

In this embodiment, the electron transport layer 18 includes a silane compound which is represented by general formula [1]:

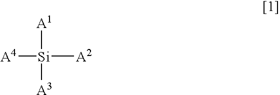

wherein A¹, A², A³ and A⁴, are each independently an alkyl group, an aryl group, a heteroaryl group or an alkynyl group.

One example of the silane compounds is represented by general formula [2]:

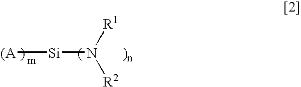

wherein A represents an alkyl group, an aryl group, a heteroaryl group or an alkynyl group. R¹ and R² represent a substituent group or a hydrogen atom. Also, m and n are integers and satisfy the relationship of m+n=4.

In the preferred embodiment of the invention, the silane compound is dicarbazolyldiphenyl silane (TH-4) represented by formula [3]:

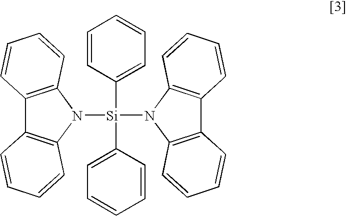

Also, an n-type material could be further included in the electron transport layer 18. The n-type material includes a metal oxide and an organic metallic salt.

Examples of the cation of the metal oxide may be lithium ion (Li⁺), sodium ion (Na⁺), potassium ion (K⁺), cesium ion (Cs⁺), magnesium ion (Mg²⁺), calcium ion (Ca²⁺) and barium ion (Ba²⁺). Examples of the anion of the metal oxide may be oxygen ion (O²⁻), fluorine ion (F⁻), chlorine ion (Cl⁻), bromine ion (Br⁻), iodine ion (I⁻), carbonate ion (CO₃²⁻), nitrate ion (NO₃⁻) and acetate ion (CH₃CO⁻).

Examples of the cation of the organic metallic salt may be lithium ion (Li⁺), sodium ion (Na⁺), potassium ion (K⁺), cesium ion (Cs⁺), magnesium ion (Mg²⁺), calcium ion (Ca²⁺) and barium ion (Ba²⁺). Examples of the anion of the organic metallic salt may be the organic anion of the aliphatic group or the aromatic group having carbon atoms equal to or less than 30.

The hole transport layer 14 includes amine derivatives, such as 4,4′,4″-tris(2-naphthylphenylamino) triphenyl-amine (2T-NATA, supplied by Kodak Cop.) or diamine derivatives, such as N,N-bis-(1-naphthyl)-N,N-diphenyl-1,1-biphenyl-4,4-diamine (NPB, supplied by Kodak Cop.), and N′-diphenyl-N,N′-bis(3-methylphenyl)(1,1′-biphenyl)-4,4′-diamine (TPD, supplied by Kodak Cop.). Additionally, the hole transport layer 14 may include a silane compound, which is used as the material of the electron transport layer 18.

Examples of the hole injection layer 12 include a compound containing fluorine, carbon and hydrogen, a porphyrin derivative and a p-doped amine derivative. The porphyrin derivative could be a metallophthalocyanine derivative, such as copper phthalocyanine.

Material of the electron injection layer 20 could be an alkaline metal halide, an alkaline-earth metal halide; an alkaline metal oxide, or a metal carbonate. Examples of the electron injection layer 20 may be lithium fluoride (LiF), cesium fluoride (CsF), sodium fluoride (NaF), calcium fluorid (CaF₂), lithium oxide (Li₂O), cesium oxide (Cs₂O), sodium oxide (Na₂O), lithium carbonate (Li₂CO₃), cesium carbonate (Cs₂CO₃), and sodium carbonate (Na₂CO₃).

Additionally, the thickness of the electron transport layer 18 ranges from about 100 Å to about 500 Å, and is preferably about 300 Å. The thickness of the hole transport layer 14 ranges from about 50 Å to about 5000 Å. The thickness of the light emitting layer 16 ranges from about 50 Å to about 5000 Å. The thickness of the electron injection layer 20 ranges from about 1 Å to about 300 Å.

### RELATIVE EXPERIMENTS

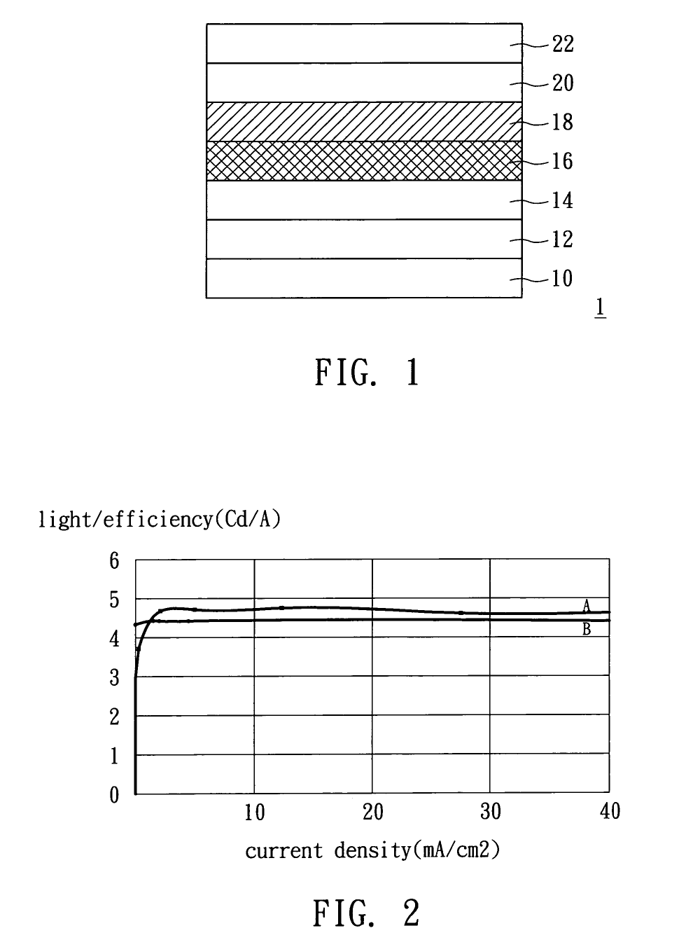

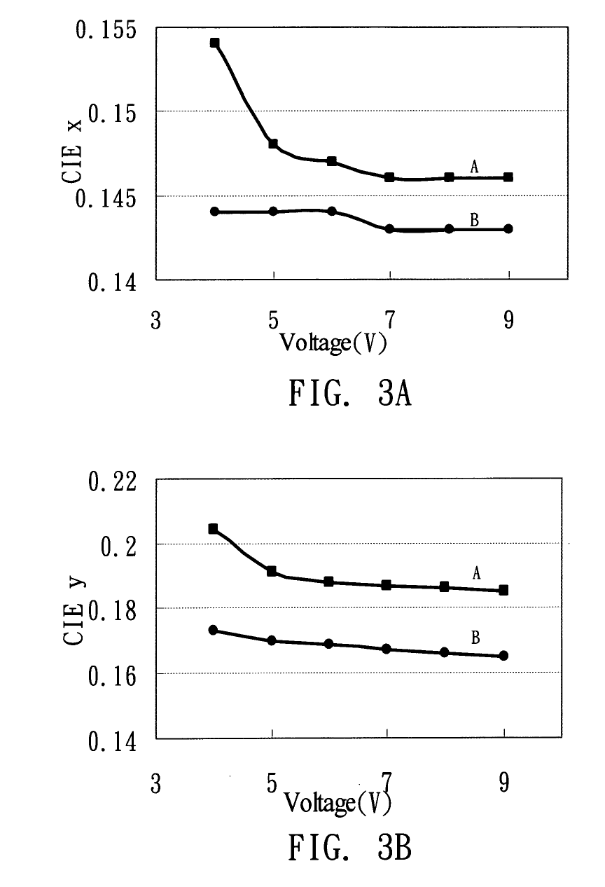

Two experiments are conducted in a comparative example and an inventive example. The procedures prepared for constructing the OELD structures of the experiments are described below. The results of the light-emitting efficiency of the OELD structures are presented in FIG. 2. The results of CIE colors of the light emitted from the OELD structures are presented in FIG. 3A and FIG. 3B. The OELD structures of the comparative example and the inventive example could be referred to FIG. 1. Also, the materials emitting blue light are applied in the light emitting layer of the OELD structures herein.

### COMPARATIVE EXAMPLE

First, a substrate having an anode, such as a transparent glass deposited with indium tin oxide (ITO) served as the anode, is provided. A hole injection layer (HIL) is deposited on the anode, and a hole transport layer (HTL) is deposited on the HIL. Then, the blue light-emitting material such as [MADN:TBPe], is deposited on the HTL as a light emitting layer. Next, an electron transport layer (ETL) [Alq3], an electron injection layer (EIL) and a cathode are laminated in order. After assembly, the OELD structure is completed.

Thus, the OELD structure of comparative example can be represented as:

Anode [ITO]/HIL/HTL/light emitting layer (Blue light)/ETL [Alq3]/EIL/Cathode

Also, the curves A of FIG. 2, FIG. 3A and FIG. 3B represent the results of comparative examples of the OELD structure.

### INVENTIVE EXAMPLE

First, a substrate having an anode, such as a transparent glass deposited with indium tin oxide (ITO) thereon served as the anode, is provided. A hole injection layer (HIL) is deposited on the anode, and a hole transport layer (HTL) is deposited on the HIL. Then, the blue light-emitting material such as [MADN:TBPe], is deposited on the HTL as a light emitting layer. Next, an electron transport layer (ETL) containing TH-4 (i.e. a silane compound) and CsF (i.e. n-type material) is deposited on the light emitting layer. The ratio of TH-4 to CsF is about 0.5 to 0.5. Then, an electron injection layer (EIL) and a cathode are laminated in order. After assembly, the OELD structure is completed.

Thus, the OELD structure of inventive example can be represented as:

Anode [ITO]/HIL/HTL/light emitting layer (Blue light)/ETL([TH-4]:[CsF]=0.5:0.5)/EIL/Cathode

Also, the curves B of FIG. 2, FIG. 3A and FIG. 3B represent the results of inventive example of the OELD structure.

The results of FIG. 2 have indicated that the light efficiency of the OELD structure of comparative example (i.e. curve A) is about 4.6 Cd/A, and the light efficiency of the OELD structure of inventive example (i.e. curve B) is about 4.2 Cd/A. The performances on light efficiencies of two OELD structures are quite similar.

The results of FIG. 3A and FIG. 3B have indicated that CIEx and CIEy of the curves B are larger than CIEx and CIEy of the curves A, respectively. According to the supplementary colorimetric standard system, smaller CIEx and CIEy represent more saturated blue color. Since the blue light-emitting material is applied in the OELD structures, the performance on color of the OELD structure of inventive example is better than that of comparative example.

It is noted that the OELD structure of inventive example can emit more saturated red light or green light than the OELD structure of comparative example if red or green light-emitting material is applied to the OELD structures.

While the invention has been described by way of example and in terms of the preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A silane compound of formula (I): 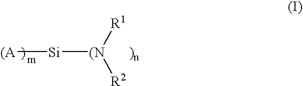
wherein R¹ and R² are each independently selected from a substituent group or a hydrogen atom, m and n are integers and satisfy the relationship of m+n=4, and A is selected from an alkyl group, an aryl group, a heteroaryl group, or an alkynyl group.

2. An organic electroluminescence device (OELD), comprising:
an anode;
a hole transport layer formed over the anode;
an organic light emitting layer formed over the hole transport layer;
an electron transport layer formed above the organic light emitting layer, the electron transport layer including a silane compound represented by the general formula: 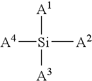
wherein A¹, A², A³ and A⁴ are each independently selected from an alkyl group, an aryl group, a heteroaryl group, or an alkynyl group; and
a cathode formed over the electron transport layer.

3. The OELD according to claim 2, wherein the silane compound is a compound represented by the general formula: 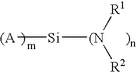
wherein R¹ and R² are each independently selected from a substituent group or a hydrogen atom; m and n are integers and satisfy the relationship of m+n=4.

4. The OELD according to claim 3, wherein A is selected from an alkyl group, an aryl group, a heteroaryl group, or an alkynyl group.

5. The OELD according to claim 2, wherein the electron transport layer further includes an n-type material.

6. The OELD according to claim 3, wherein the n-type material comprises a metal oxide or an organic metallic salt.

7. The OELD according to claim 4, wherein a cation of the metal oxide includes lithium ion (Li⁺), sodium ion (Na⁺), potassium ion (K⁺), cesium ion (Cs⁺), magnesium ion (Mg²⁺), calcium ion (Ca²⁺) or barium ion (Ba²⁺); an anion of the metal oxide includes oxygen ion (O²⁻), fluorine ion (F⁻), chlorine ion (Cl⁻), bromine ion (Br⁻), iodine ion (I⁻), carbonate ion (CO₃²⁻), nitrate ion (NO₃⁻), or acetate ion (CH₃COO⁻).

8. The OELD according to claim 4, wherein a cation of the organic metallic salt includes lithium ion (Li⁺), sodium ion (Na⁺), potassium ion (K⁺), cesium ion (Cs⁺), magnesium ion (Mg²⁺), calcium ion (Ca²⁺), or barium ion (Ba²⁺); and an anion of the organic metallic salt includes an organic anion of the aliphatic group or the aromatic group having carbon atoms equal to or less than 30.

9. The OELD according to claim 2, wherein the silane compound is dicarbazolyldiphenyl silane (TH-4) represented by the general formula:

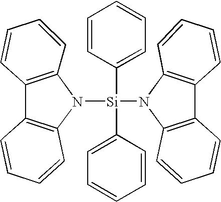

10. The OELD according to claim 2, wherein a thickness of the electron transport layer ranges from about 100 Å to about 500 Å.

11. The OELD according to claim 10, wherein the thickness of the electron transport layer is about 300 Å.

12. The OELD according to claim 2, wherein the hole transport layer further includes an amine derivative or an diamine derivative.

13. The OELD according to claim 12, wherein the diamine derivative is N,N-bis-(1-naphthyl)-N,N-diphenyl-1,1-biphenyl-4,4-diamine (NPB), or N′-diphenyl-N,N′-bis(3-methylphenyl)(1,1′-biphenyl)-4,4′-diamine (TPD).

14. The OELD according to claim 12, wherein the amine derivative is 4,4′,4″-tris(2-naphthylphenylamino) triphenyl-amine (2T-NATA).

15. The OELD according to claim 12, wherein a thickness of the hole transport layer ranges from about 50 Å to about 5000 Å.

16. The OELD according to claim 2, wherein a thickness of the organic light emitting layer ranges from about 50 Å to about 5000 Å.

17. The OELD according to claim 2, further comprising:
a hole injection layer disposed between the anode and the hole transport layer.

18. The OELD according to claim 17, wherein the hole injection layer comprises a porphyrin derivative, a p-doped diamine derivative, or a compound containing fluorine, carbon and hydrogen.

19. The OELD according to claim 18, wherein the porphyrin derivative comprises a metallophthalocyanine derivative.

20. The OELD according to claim 19, wherein the metallophthalocyanine derivative is copper phthalocyanine.

21. The OELD according to claim 2, further comprising:
an electron injection layer disposed between the cathode and the electron transport layer.

22. The OELD according to claim 21, wherein the electron injection layer includes an alkaline metal halide, an alkaline-earth metal halide, an alkaline metal oxide, or a metal carbonate.

23. The OELD according to claim 21, wherein the electron injection layer includes lithium fluoride (LiF), cesium fluoride (CsF), sodium fluoride (NaF), calcium fluorid (CaF₂), lithium oxide (Li₂O), cesium oxide (Cs₂O), sodium oxide (Na₂O), lithium carbonate (Li₂CO₃), cesium carbonate (Cs₂CO₃), or sodium carbonate (Na₂CO₃).

24. The OELD according to claim 21, wherein a thickness of the electron injection layer ranges from about 1 Å to about 300 Å.

25. The OELD according to claim 2, wherein the hole transport layer includes the silane compound.

26. An electroluminescent display panel comprising the organic electroluminescent device of claim 2.
